(19) United States
(12) Patent Application Publication
(10) Pub. No.: US 2015/0027160 A1
(43) Pub. Date: Jan. 29, 2015

(54) Portable Air Conditioning Device for Vehicles

(71) Applicant: Shea Patrick Callahan, Hereford, AZ (US)

(72) Inventor: Shea Patrick Callahan, Hereford, AZ (US)

(21) Appl. No.: 14/272,623

(22) Filed: May 8, 2014

Related U.S. Application Data
(60) Provisional application No. 61/857,389, filed on Jul. 23, 2013.

(51) Int. Cl. B60H 1/32

(52) U.S. Cl. CPC B60H 1/32
USPC 62/419; 62/407

(57) ABSTRACT

Disclosed is a portable air conditioning device for vehicles. The device includes an air duct system and an exhaust pipe that is connected to a housing member that encloses a compressor, an air condenser, a power supply, and a dual fan system with a fan speed control switch that is connected to one or more capacitors. The duct system supplies cool, filtered air to the interior of a vehicle while the exhaust pipe releases heat to the outdoors. The device may be internally powered via a battery or externally powered via a power adaptor or outlet. The device may be conveniently placed inside of a vehicle and secured in place via a strap system disposed thereon. In this way, the device may be ideally used with existing vehicles lacking an operable air conditioning system. Additionally, the device may be used to supplement an operable air conditioning system for a vehicle.

### CROSS REFERENCE TO RELATED APPLICATION

This application claims the benefit of U.S. Provisional Application No. U.S. 61/857,389 filed on Jul. 23, 2013. The above identified patent application is herein incorporated by reference in its entirety to provide continuity of disclosure.

### BACKGROUND OF THE INVENTION

1. Field of the Invention

The present invention relates to an air conditioning device for vehicles. More specifically, the present invention pertains to a portable air conditioning device that provide a flexible duct system to circulate cool, filtered air within the interior of a vehicle while releasing hot air to the outdoors. The present air conditioning device may be used with existing vehicles having no air conditioner or to replace an inoperable air conditioner.

Vehicle air conditioning systems cool the occupants of a vehicle in hot weather, and have come into wide and popular use throughout the automobile industry. Most air conditioning systems are installed into vehicles during manufacturing process. These systems use an engine-mounted compressor, driven off of the crankshaft of the engine via a drive belt, with an evaporator in the trunk of a vehicle to deliver cold air through the rear parcel shelf and overhead vents. In this way, vehicle air conditioning systems move heat from inside of a vehicle to the outdoors. Conventional air conditioning systems, however, decrease the fuel efficiency of a vehicle because these systems use energy supplied by the alternator, which comes from the engine that uses the fuel. The air conditioning systems cannot function properly when the vehicle is not running because the belt that engages the compressor, which is used to compress the coolant, will only run with the engine started.

Additionally, diagnosing and repairing vehicle air conditioning system can be very complicated. This is especially true for older vehicles that use dichlorodifluoromethane (R-12) refrigerant, which is becoming increasingly more expensive and difficult to find because its manufacture was banned in the United States due to concerns about damage to the ozone layer. For this reason, users handling dichlorodifluoromethane (R-12) refrigerant must be certified by the Environmental Protection Agency (EPA). As such, repairing vehicle air conditioning system can be costly and inconvenient.

On the other hand, vehicles without air conditioning system subject passengers to excessive heat, which may be potentially dangerous during hot weather. Nonetheless, it is impracticable and expensive to install an air conditioning system to existing vehicles. More specifically, installing a new air conditioning system to an existing vehicle requires a user to modify the structure of the vehicle. It is recognized that portable cooling units may be used as a means of cooling the interior of a vehicle. It is submitted, however, that existing portable cooling units are bulky and lack the means to secure the cooling unit to the inside of a vehicle, and further lack means to effectively ventilate cool and hot air.

The present invention provides a portable air conditioning device for vehicles. The present invention may be internally powered via a battery or externally powered via a power adapter or the like. The device may be ideally used with existing vehicles having inoperable air conditioner or used with vehicles without an air conditioning system. However, the present invention may also supplement cooling power when existing vehicle air conditioner has a difficult time controlling temperature. By cooling the air, the present invention creates a cooler environment and help lower humidity levels, which also discourage dust mites and mold from forming inside of a vehicle. The primary advantage of the present invention is not only its portable design, but more specifically the exhaust pipe feature which facilitate the release of hot air from the capillary tubes while the device is in use.

2. Description of the Prior Art

Devices have been disclosed in the prior art that relate to air conditioning systems for vehicles, and further to those emphasizing portability of the system. These include devices that have been patented and published in patent application publications. Some of these patents describe air conditioners that are built into vehicles during the manufacturing process. Others describe portable air conditioner devices that that utilize air vents disposed on the housing of the air conditioner. These devices, however, are not specifically designed to be used with existing vehicles and lack flexible air duct system to facilitate the direction of the air flow within the interior of a vehicle. The following is a list of devices deemed most relevant to the present disclosure, which are herein described for the purposes of highlighting and differentiating the unique aspects of the present invention, and further highlighting the drawbacks existing in the prior art.

For example, U.S. Pat. No. 5,927,089 to O'Donnell discloses an air conditioner for a motor vehicle comprising an internal combustion engine and a sealed envelope that encloses an electrical motor that drives a compressor for a refrigerant fluid. Additionally, the O'Donnell device includes a plurality of attachment means to mount various components of the device in a motor vehicle. While the O'Donnell device discloses an air conditioner for use in a motor vehicle, the O'Donnell device is limited in the fact that it cannot be used with existing vehicles having an inoperable air conditioning system or vehicles having no air conditioning system. The present invention provides a portable air conditioning device that may be used with both new and existing vehicles, providing versatility with regard to its application with a wide variety of vehicles.

U.S. Pat. No. 5,193,609 to Cowart describes a low profile heating and cooling unit for vehicles comprising a coil housing that encloses a temperature exchange coil and a blower motor. The blow motor is further coupled to a motor mount at the exhaust port, which is affixed to the motor shaft and the blower wheel. The blower motor pulls air from the interior of the vehicle and through the temperature exchange coils by rotating the blower wheel, thereby facilitating in delivering heated or cooled air to the interior of the vehicle. Cowart, however, does not disclose a flexible air duct system with which to provide direct air flow to a driver and a passenger. Additionally, the device of Cowart discloses a plenum having a baffle, which does not allow the user to control the direction and the amount of air flow. In contrast, the present invention provides a flexible air duct system comprising one or more air duct hoses, wherein each air duct hose includes an adjustable vent that open and close as desired by the user. In this way, the present invention increases user operation and control of the device.

Another device, U.S. Pat. No. 5,737,938 to Liu discloses an air conditioning system with portable air conditioning unit. The air conditioning unit comprises a housing that is mounted on a stand, wherein the housing encloses a freezer, a fan, a perforated air-distributor, and coolant carriers. The air stream passes through the fan, then passes through the perforated air-distributor, and the coolant carriers. The air is then passed through an air outlet disposed on the housing. While the air conditioning unit of Liu may disclose a stand on which the housing may be placed, the purpose and design of the Liu device differ from the present invention, which is adapted for use in vehicles. As such, the present invention discloses a strap that may be secured around the vehicle seat or center console so that the device is prevented from shifting or tipping over while in use.

Finally, U.S. Pat. No. 4,841,742 to Biby discloses a portable air conditioner for automotive vehicles comprising an insulated housing, internal cooling heat exchanger, a blower fan, and inlet and outlet ports. The device further comprises a coolant that last up to approximately four days, which may be ice with anti-freeze or salt additives. The device is operable via battery or external power supply. While Biby discloses a portable air conditioner for vehicles, the structure of the present invention differs from the structure of Biby device in that Biby discloses use of ice that melts in a drain plug. As such, the melted ice needs to be drained. In contrast, the present invention utilizes refrigerant that may be evaporated, eliminating the need to drain any fluid after use. In this way, the present invention provides convenience to the user.

These prior art devices have several known drawbacks. The present invention is adapted to provide air conditioning system for vehicles without an existing air conditioning system or for vehicles without an operable air conditioning system. The present invention do not require structural modification to the vehicle, and offer the flexibility of being able to move as necessary. The present invention will facilitate in cooling the interior of a vehicle in hot weather to provide a comfort to the passengers. The housing is designed to be compact so that it may be placed in the interior of a vehicle, while the strap secures the device in place. Additionally, the air duct hoses can be easily maneuvered to direct air flow to the driver and the passenger. It is therefore submitted that the present invention substantially diverges in design elements from the prior art, which overcomes the disadvantages of the prior art devices, and consequently it is clear that there is a need in the art for an improvement to existing air conditioning systems for vehicles. In this regard the instant invention substantially fulfills these needs.

### SUMMARY OF THE INVENTION

In view of the foregoing disadvantages inherent in the known types of air conditioning systems for vehicles now present in the prior art, the present invention provides a new improvement to a portable air conditioning device for vehicles wherein the same can be utilized for cooling the interior of a vehicle.

It is therefore an object of the present invention to provide a new and improved portable air conditioning device for vehicles that has all of the advantages of the prior art and none of the disadvantages.

It is another object of the present invention to provide a new and improved portable air conditioning device for vehicles having an air duct system that includes one or more flexible air duct hoses with adjustable vents to control the direction of the air flow to the occupants of a vehicle.

Another object of the present invention is to provide a new and improved portable air conditioning device for vehicles having a dual fan system with a fan speed control switch that is connected to one or more capacitors to control the amount of air flow to the occupants of a vehicle.

Yet another object of the present invention is to provide a new and improved portable air conditioning device for vehicles that is compact in design for use with new or existing vehicles without modifying the structure of the vehicles.

Still yet another object of the present invention is to provide a new and improved portable air conditioning device for vehicles that is externally powered via a retractable power supply adapter or a retractable outlet plug.

Still yet another object of the present invention is to provide a new and improved portable air conditioning device for vehicles that may filter hot air through an exhaust pipe having a flat tip and one or more suction cups disposed thereon.

Still yet another object of the present invention is to provide a new and improved portable air conditioning device for vehicles that includes a strap system to secure the device to the interior of a vehicle.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and in manner in which it may be made and used may be better understood after a review of the following description, taken in connection with the accompanying drawings wherein like numeral annotations are provided throughout.

FIG. 1 shows a perspective view of the present invention.

FIG. 2 shows a schematic diagram of the present invention.

FIG. 3 shows an embodiment of the present invention having a belt-style strap.

FIG. 4 shows another embodiment of the present invention having a hook and loop strap.

FIG. 5 shows a view of the present invention as placed inside of a vehicle.

### DETAILED DESCRIPTION OF THE INVENTION

Reference is made herein to the attached drawings. Like reference numerals are used throughout the drawings to depict like or similar elements of the portable air conditioning device for vehicles. For the purposes of presenting a brief and clear description of the present invention, the preferred embodiment will be discussed as used for cooling the interior of a vehicle. The figures are intended for representative purposes only and should not be considered to be limiting in any respect.

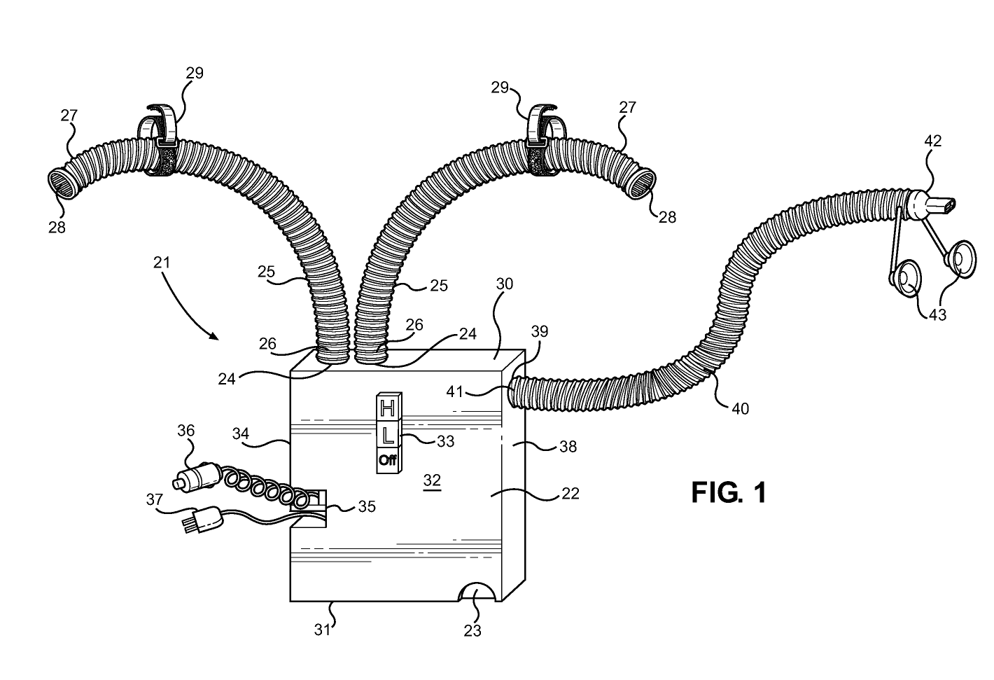

Referring now to FIG. 1, there is shown a perspective view of the present invention. The present invention is a compressor-based refrigerant system that uses air to exchange heat. The present air conditioning device 21 comprises a housing 22 that is composed of rigid material such as durable plastic or thin metal. The housing comprises a closed top 30, bottom 31, and sidewalls, forming an internal volume adapted to enclose various air conditioner parts therein. The closed bottom 31 wall may include a cylindrical cavity 23, wherein the cavity 23 is dimensioned to receive a standard air-conditioning canister therein. When the canister is placed inside the cavity 23, it is secured in an upright position. The closed top portion 30 of the housing 22 comprises one or more outlet ports 24, wherein each port 24 is adapted to receive an air duct hose 25. In the illustrated embodiment, the top portion 30 comprises two outlet ports 24 wherein each outlet port is adapted to receive an air duct hose 25.

Each air duct hose 25 may be manufactured from one or more plastic materials and may have a flexible, accordion-like structural configuration to facilitate movement thereof. The air duct hose comprises a first 26 and a second end 27, wherein the first end 26 is connected to the outlet port disposed on the top portion of the housing. The perimeter of the first end 26 is sealed around the outlet port 24 to prevent air leakage. The second end 27 of the air duct hose comprises an adjustable air vent 28 that enables a user to control the direction and the amount of the air flow. Additionally, the second end 27 of the air duct hose 25 comprises a hook and loop fastener 29, which may be used to secure the second end 27 of the air duct hose 25 to a desired location inside of the vehicle. One air duct hose is adapted to deliver cool air to the driver, while another air duct hose is adapted to deliver cool air to the passenger. However, the air duct hose 25 may be positioned in any part of the vehicle where the air flow is desired.

The housing 22 further comprises a first sidewall 32 opposite a second sidewall, and a third sidewall opposite a fourth sidewall. The first sidewall 32 comprises a combination power switch and a fan speed control switch. In the exemplary embodiment, the first sidewall 32 includes a speed control switch 33 for a two-speed fan disposed within the interior volume of the housing. More specifically, the exemplary embodiment comprises an off mode, a low speed setting, and a high speed setting. In alternate embodiments, however, the present invention may provide multiple speeds to suit the preferences of a user. Additionally in some embodiments, the present invention may comprise a digital display to show the temperature of the interior of the vehicle in which the air conditioning device is placed.

The third sidewall 34 comprises a recessed portion 35 that is adapted to store retractable power adapters and/or cables therein. More specifically, the device may include a retractable 12 volt power supply adapter 36 and a standard outlet plug 37. Each of the power supply adapter 36 and the standard outlet plug 37 comprises a first and second ends wherein the second ends are connected to the electrical components disposed inside the housing 22. Each of the power supply adapter 36 and the standard outlet plug 37 may be coiled around a spring-biased reel so that each of the adapter 36 and the plug 37 may be extended or retracted through an aperture disposed in the recessed portion 35. In this way, the power supply adapter 36 and the outlet plug 37 may be adjusted to various lengths as needed.

The fourth sidewall 38 comprises an exhaust port 39 near the top portion of the housing. The exhaust port 39 is adapted to receive an exhaust pipe 40 therein. Similar to the air duct hose, the exhaust pipe 40 may be manufactured from one or more plastic materials and may have a flexible, accordion-like structural configuration to facilitate movement thereof. The exhaust pipe 40 comprises a first 41 and a second end 42, wherein the first end 41 is connected to the exhaust port 39 disposed on the fourth sidewall 38 of the housing 22. The perimeter of the first end 41 is sealed around the exhaust port 39 to prevent any air leakage therefrom. The second end 42 of the pipe 40 is flat in structural configuration, so that it may be held or wedged between the window and the vehicle door frame. In this way, the exhaust pipe 40 can release hot air produced from the interior of the housing 22 to the outdoors. Additionally, the second end 42 of the pipe 40 comprises one or more suction cup 43 attached thereto. The suction cups 43 may be attached to the pipe 40 via a strap or the like. The suction cups 43 help to secure the second end 42 of the pipe 40 to the window and prevent the pipe 40 from slipping or falling down. Optionally, the exhaust pipe 40 may include a warning indicator to alert the user of the heated air that is blown therefrom.

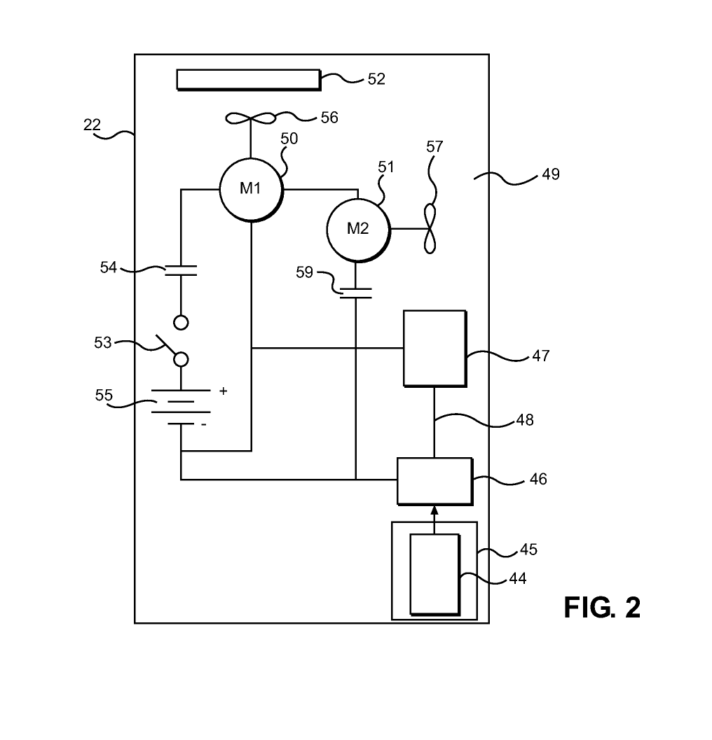

Referring now to FIG. 2, there is shown a schematic diagram of the housing of the present invention. The internal volume 49 of the housing 22 comprises a receptacle 45 for an air conditioner refrigerant canister or aerosol spray can 44. The present invention is adapted for use with a wide variety of metal canisters or aerosol spray cans. The canister or spray can contains stable, nonflammable refrigerant such as ammonia, sulfur dioxide, and non-halogenated hydrocarbons, including propane. The canister or spray can 44 includes a top portion with connecting means such as threaded elements for connecting the refrigerant canister 44 directly to a compressor 46. The compressor 46 compresses refrigerant in liquid state and sends it to an air condenser 47 via coils or tubes, such as capillary tubes 48. As the refrigerant travels through capillary tubes 48, the highly pressurized liquid refrigerant converts to a gas, and the heat from the gas is quickly released, causing the gas to cool. Some of the remaining cooled gas that reaches the air condenser 47 reverts back into liquid form as it returns to the compressor 46 through the capillary tubes 48.

The internal volume 49 of the housing 22 is equipped with a dual fan system. The dual fan system comprises a two-speed fan 56 and an exhaust fan 57. The two-speed fan 56 is adapted to force the cooled gas through an air filter 52 to eliminate any debris before the cooled gas is directed toward the outlet port connected to the air duct hose. The filter 52 may be in a form of pleated fibrous materials which removes solid particulates such as dust, pollen, mold, and bacteria from the air. The fan speed may be determined via a fan speed control switch 53. The switch 53 communicates with a capacitor 54, which control the flow of power to a fan motor 50. The capacitor 54 receives all of the power from a power source 55, which may be supplied internally from a battery or externally via a 12 volt power supply adapter or a standard outlet plug. The capacitor 54 then meters how much of that power the fan motor 50 actually receives. For instance, if the switch is set to fifty percent power at a low setting, the capacitor 54 supplies the motor 50 with fifty percent of the power at a low setting.

The heat generated from the energy spent to cool the air is released through the exhaust port connected to the exhaust pipe. An exhaust fan 57 is utilized to force the hot air through the exhaust pipe from the internal volume 49 of the housing 22. The exhaust fan 57 comprises a single-speed mode, and the exhaust fan motor 51 is actuated via the fan speed control switch 53. The switch also communicates with a second capacitor 59 that supply power to the exhaust fan motor 51. Releasing hot air prevent moisture or water from forming in the internal volume 49 of the housing 22, thereby eliminating the need to collect the moisture in a drip pan or bucket for disposal.

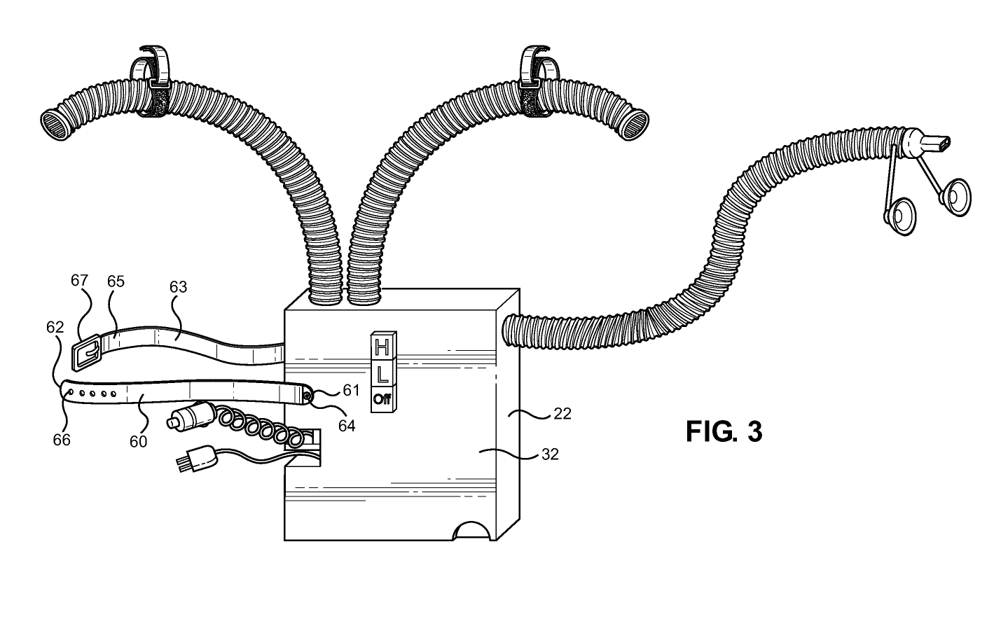

Referring now to FIG. 3 there is shown an embodiment of the present invention having a belt style strap system thereon. The first sidewall 32 of the housing 22 includes a first strap 60 having a first 61 and second ends 62. Similarly, the second sidewall of the housing 22 includes a second strap 63 having a first and second ends 65. The straps 60, 63 may be composed of durable material such as nylon, polyester, polypropylene, leather, or other suitable material. The first end 61 of the first strap 60 is affixed to the first sidewall 32 via fasteners 64 such as screws, or other suitable means. The second end 62 of the first strap 60 comprises a series of apertures 66 disposed along its length, wherein the apertures 66 are spaced at regular intervals.

The first end of the second strap 63 is affixed to the second sidewall via fasteners such as screws, or other suitable means. The second end 65 of the second strap 63 comprises a belt buckle 67. The belt buckle may be composed of rigid material such as metal. The belt buckle 67 comprises a rectangular frame having a first side opposite a second side. The first side of the belt buckle 67 comprises a prong having an attachment end and a terminal end, wherein the attachment end is wrapped around the first side of the belt buckle 67. The terminal end of the prong is adapted to extend through one of the apertures 66 disposed on the first strap 60. Thereafter, the prong anchors against the second side of the frame, adjustably securing the second strap 63 to the first strap 60 and around a vehicle seat or center console.

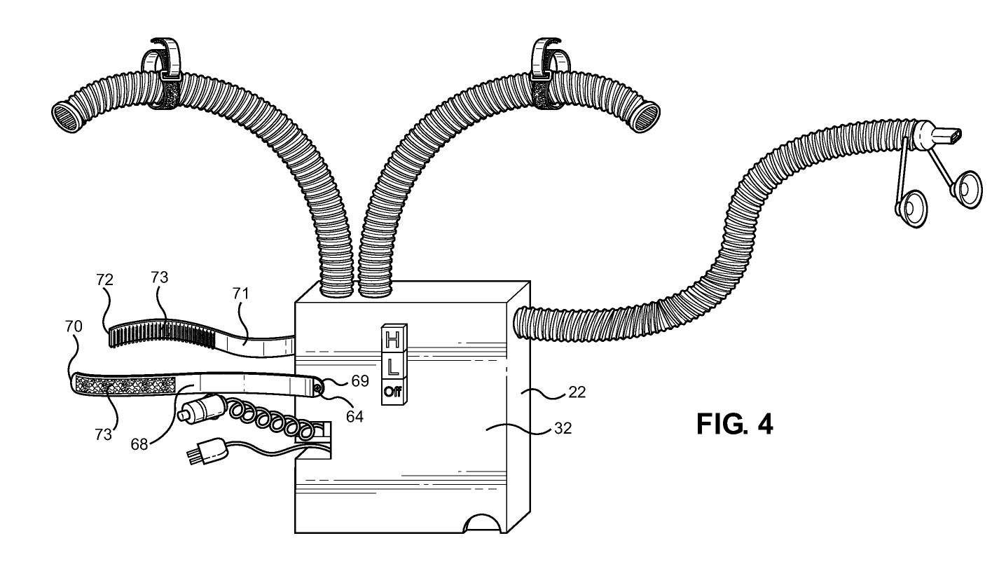

Referring now to FIG. 4, there is shown an embodiment of the present invention having a hook and loop fastening system thereon. The first side wall 32 of the housing 22 includes a first strap 68 having a first 69 and second ends 70. Similarly, the second sidewall of the housing 22 includes a second strap 71 having a first and second ends 72. The straps 68, 71 may be composed of durable material such as nylon, polyester, polypropylene, leather, or other suitable material. The first end 69 of the first strap 68 is affixed to the first sidewall 32 via fasteners 64 such as screws, or other suitable means. The second end 70 of the first strap comprises hook and loop fastener material 73.

The first end of the second strap 71 is affixed to the second sidewall via fasteners such as screws, or other suitable means. The second end 72 of the second strap 71 comprises hook and loop fastener material 73. The second ends 70, 72 of the first 68 and second straps 71 may be overlapped so that the present air conditioning device may be adjustably secured around a vehicle seat or center console. Any suitable fastener may be used, such as buttons, snaps, ties, hooks, clasps, or in a preferred embodiment of the present invention, hook and loop fastening material 73.

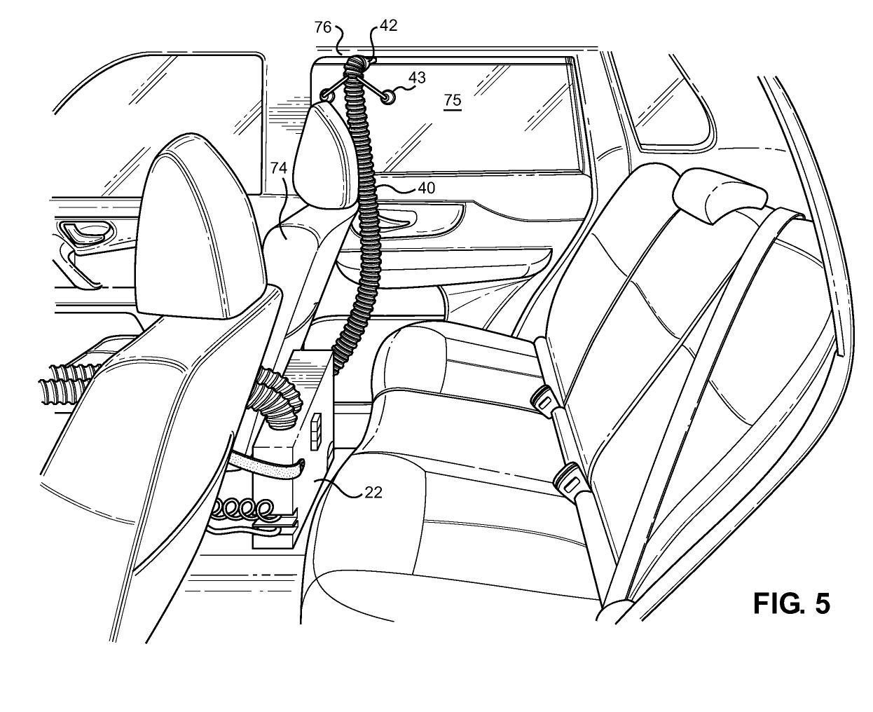

Referring now to FIG. 5, there is shown a view of the present invention as placed inside of a vehicle. The device is placed inside of a vehicle, such as the area behind the front seat of the vehicle, or the area behind the center console. The housing 22 may be secured to the front seat 74 or to the center console. The second end 42 of the exhaust pipe 40 may be extended toward the window, and wedged between the window 75 and the vehicle door frame 76. The second end 42 of the exhaust pipe 40 should face outward to direct hot air produced from the device to the outdoors. Additionally, the suction cups 43 may be placed on the window 75 to prevent the second end 42 of the exhaust pipe 40 from falling off of its place. Releasing hot air to the outdoors increases the efficiency of the present invention by maintaining cool temperature inside of the vehicle.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A portable air conditioning device for vehicles, comprising:
a boxlike housing having a top surface, a bottom surface, upstanding sidewalls, forming an interior volume;
an opening through said base surface, wherein said opening is adapted to receive a refrigerant canister therein;
at least one outlet port disposed on said housing;
at least one flexible air duct hose having a first end and a second end;
said first end of said least one air duct hose connected to said least one outlet port to direct movement of cool air;
an exhaust port disposed on said housing;
a flexible exhaust pipe having a first end and a second end;
said first end of said exhaust pipe connected to said exhaust port to direct movement of hot air;
at least one power plug connected to said housing.

2) The portable air conditioning device of claim 1, wherein said interior volume of said housing comprises:
a compressor that is connected to said refrigerant canister;
an air condenser;
a tube connecting said air condenser and said compressor;
at least one fan system having a fan and a fan motor attached thereto;
at least one capacitor;
wherein said least one capacitor supplies power to said fan motor; and
an air filter.

3) The portable air conditioning device of claim 2, further comprising:
a fan speed control switch on said housing;
said fan speed control switch adapted to communicate with said least one capacitor.

4) The portable air conditioning device of claim 2, further comprising:
a first fan system having a two-speed setting;
a second fan system having a single-speed setting.

5) The portable air conditioning device of claim 2, wherein said tube comprises a capillary tube.

6) The portable air conditioning device of claim 1, wherein said least one power plug is retractable.

7) the portable air conditioning device of claim 1, wherein said least one air duct hose is accordion-like.

8) The portable air conditioning device of claim 1, wherein said exhaust pipe is accordion-like.

9) The portable air conditioning device of claim 1, wherein said second end of said exhaust pipe is flat.

10) The portable air conditioning device of claim 1, wherein said exhaust pipe further comprises at least one suction cup attached near said second end of said exhaust pipe.

11) The portable air conditioning device of claim 1, wherein said second end of said least one air duct hose further comprises an adjustable air vent.

12) The portable air conditioning device of claim 2, further comprising a battery.

13) The portable air conditioning device of claim 1, wherein said least one power plug comprises a power adapter.

14) The portable air conditioning device of claim 1, wherein said least one power plug comprises an electrical outlet plug.
